(19) United States
(12) Patent Application Publication
(10) Pub. No.: US 2026/0366675 A1
(43) Pub. Date: Nov. 19, 2026

(54) PRESSURE VESSEL ASSEMBLY

(71) Applicants: Hyundai Motor Company, Seoul (KR); Kia Corporation, Seoul (KR)

(72) Inventors: Seong Nyeong Park, Hwaseong-si (KR); Jae Han Chung, Hwaseong-si (KR); Su Jin Yoon, Jeonju-si (KR); Myeong Heon Lee, Guri-si (KR)

(21) Appl. No.: 19/380,424

(22) Filed: Nov. 5, 2025

(30) Foreign Application Priority Data
May 14, 2025 (KR) 10-2025-0062805

(51) Int. Cl. F17C 1/16

(52) U.S. Cl. CPC F17C 1/16; F17C 2201/0109; F17C 2203/012; F17C 2203/0604; F17C 2203/0621; F17C 2203/0624; F17C 2203/066; F17C 2221/012; F17C 2260/011; F17C 2270/0171; F17C 2270/0184

(57) ABSTRACT

According to one aspect, a pressure vessel assembly may include a pressure vessel including a cylinder part, dome parts having dome shapes formed at two opposite longitudinal ends of the cylinder part, and a nozzle part inserted into an opening portion formed at one side of the dome part, and protectors provided to surround outer peripheral surfaces of the dome parts, in which the dome parts include a first dome part having a dome shape formed at one longitudinal end of the cylinder part, and a second dome part having a dome shape formed at the other longitudinal end of the cylinder part, and in which the protector includes a guide portion extending outward in the longitudinal direction along a periphery of the opening portion, and one or more protruding portions protruding outward in the longitudinal direction from at least a partial region of the guide portion.

### CROSS REFERENCE TO RELATED APPLICATIONS

This application claims the benefit of and priority to Korean Patent Application No. 10-2025-0062805 filed in the Korean Intellectual Property Office on May 14, 2025, the entire contents of which are incorporated herein by reference.

### TECHNICAL FIELD

The disclosed embodiment relates to a pressure vessel assembly.

### BACKGROUND

A hydrogen vehicle (e.g., a passenger vehicle or a commercial vehicle) is configured to autonomously generate electricity by means of a chemical reaction between hydrogen and oxygen and travel by operating a motor. More specifically, the hydrogen electric vehicle includes a pressure vessel configured to store hydrogen (H2), a fuel cell stack configured to produce electricity by means of an oxidation-reduction reaction between hydrogen and oxygen (O2), various types of devices configured to discharge produced water, a battery configured to store the electricity produced by the fuel cell stack, a controller configured to convert and control the produced electricity, and a motor configured to generate driving power.

A TYPE 4 pressure vessel may be used as the pressure vessel of the hydrogen vehicle. The TYPE 4 pressure vessel may include a liner (made of a nonmetallic material, for example), and a carbon fiber layer made by winding a carbon fiber composite material around an outer surface of the liner.

However, because of structural characteristics of the pressure vessel in the related art, in which two opposite dome parts of the pressure vessel each have a dome shape, it is difficult to wind a carbon fiber composite material, with a sufficient thickness, around the dome part of the pressure vessel. For this reason, a problem can arise in ensuring adequate sufficient structural rigidity of the dome part of the pressure vessel.

In particular, the dome portion of the pressure vessel is susceptible to damage or breakage when subjected to an impact (e.g., a drop or collision). As a result, there is an increased risk of hydrogen leakage and a consequent deterioration in the safety and reliability of the pressure vessel.

Therefore, recently, various studies have been conducted to ensure the structural rigidity of the pressure vessel (e.g., the structural rigidity of the dome part) and to improve the safety and reliability of the pressure vessel, but the research outcomes remain insufficient. Accordingly, there is a need to develop a technology to ensure the structural rigidity of the pressure vessel (the structural rigidity of the dome part) and improve the safety and reliability of the pressure vessel.

### SUMMARY

Embodiments of the present disclosure relate to a pressure vessel assembly provided with a protector to mitigate impact applied to a pressure vessel because of external impact such as dropping. According to disclosed embodiments, a pressure vessel assembly is capable of mitigating impact applied to a pressure vessel because of external impact such as dropping.

The disclosure describes a pressure vessel assembly that includes a pressure vessel including a cylinder part, dome parts having dome shapes formed at two opposite longitudinal ends of the cylinder part, and a nozzle part inserted into an opening portion formed at one side of the dome part. Protectors surround outer peripheral surfaces of the dome parts. The dome parts include a first dome part having a dome shape formed at one longitudinal end of the cylinder part and a second dome part having a dome shape formed at the other longitudinal end of the cylinder part. The protector includes a guide portion extending outward in the longitudinal direction along a periphery of the opening portion and one or more protruding portions protruding outward in the longitudinal direction from at least a partial region of the guide portion.

The protruding portions may extend outward in the longitudinal direction beyond an outer end of the nozzle part.

At least a partial region of a region of the guide portion, which excludes a region in which the protruding portion is provided, may have a central angle of 150 degrees or more based on a longitudinal center axis of the cylinder part.

The protectors may include a first protector surrounds an outer peripheral surface of the first dome part and a second protector surrounds an outer peripheral surface of the second dome part. The protruding portions may include a plurality of first protruding portions asymmetrically disposed on the first protector with respect to a longitudinal center axis of the cylinder part and a plurality of second protruding portions asymmetrically disposed on the second protector with respect to the longitudinal center axis.

Each of the first protruding portions may have a fan-shape that extends along an arc segment centered on a central axis, and two or more first protruding portions, among the plurality of first protruding portions, may be formed to have different central angles.

At least some of the plurality of first protruding portions may be spaced apart from at least some of the plurality of second protruding portions when the pressure vessel assembly is viewed from one side based on the longitudinal direction.

The cylinder part and the dome part may each comprise a woven fiberglass fabric.

The pressure vessel may further include a first reinforcement layer disposed along inner peripheral surfaces of the cylinder part and the dome part and a liner disposed along an inner peripheral surface of the first reinforcement layer and configured to define a storage space within the pressure vessel.

The first reinforcement layer may comprise a carbon fiber composite material, and the liner may comprise a plastic material.

Each protector may further include: a protector body fixed to the outer peripheral surface of the dome part and a second reinforcement layer disposed along an inner peripheral surface of the protector body.

The pressure vessel assembly may further include a nozzle part protector surrounding an outer peripheral surface of a region protruding outward from the nozzle part.

The nozzle part protector may include a body portion surrounding at least a portion of the pressure vessel, a connection portion extending outward in the longitudinal direction from the body portion, and one or more protrusion portions protruding outward in the longitudinal direction from one side of the connection portion.

The protrusion portion may protrude outward in the longitudinal direction beyond an outer end of the nozzle part.

At least a part of the second protruding portion and at least a portion of the protrusion portion may be positioned in different radial directions relative to a center axis of the cylinder part.

The nozzle part may include an open nozzle part having a hole configured to fluidly connect the open nozzle part to an external device and a closed nozzle part having a sealed shape to prevent leakage.

A first identification indicator may be formed on one side of the guide portion of the first protector, a second identification indicator may be formed on one side of the guide portion of the second protector, and the first and the second identification indicators may differ in arrangement or shape.

According to the disclosed embodiment, the protector installed on the dome part of the pressure vessel may mitigate impact transmitted to the pressure vessel because of external impact such as dropping.

According to the disclosed embodiment, the plurality of protruding portions and the plurality of non-protruding regions formed on the guide portion of the protector may be asymmetrically disposed, thereby guiding the tilting direction of the pressure vessel during dropping.

According to the disclosed embodiment, the plurality of protruding portions may come into contact with the ground surface first to absorb primary impact during dropping and guide the tilting of the pressure vessel, thereby preventing secondary impact and dispersing total impact step by step.

According to the disclosed embodiment, the nozzle part protector may be attached to the nozzle part, thereby guiding the tilting direction during dropping.

According to the disclosed embodiment, the reinforcement layer may be provided on the inner peripheral surface of the protector, thereby absorbing impact generated, during dropping, and reducing impact transmitted to the pressure vessel.

### BRIEF DESCRIPTION OF THE DRAWINGS

FIG. 1 is a perspective view illustrating a pressure vessel assembly according to an embodiment of the present disclosure.

FIG. 2 is a perspective view illustrating the pressure vessel assembly excluding a protector body in the embodiment in FIG. 1.

FIG. 3 is a cross-sectional view used to explain an internal configuration of the pressure vessel assembly according to the embodiment of the present disclosure.

FIG. 4 is an enlarged cross-sectional view illustrating a coupling structure between a protector and a pressure vessel according to the embodiment of the present disclosure.

FIG. 5 is an enlarged cross-sectional view illustrating the pressure vessel assembly including a second reinforcement layer according to another embodiment in FIG. 4.

FIG. 6 is a side view illustrating the pressure vessel assembly according to the embodiment of the present disclosure when viewed from a first protector.

FIG. 7 is a side view illustrating the pressure vessel assembly according to the embodiment of the present disclosure when viewed from a second protector.

FIG. 8 is a perspective view illustrating the pressure vessel assembly including a nozzle part protector according to another embodiment in FIG. 7.

FIG. 9 is a side view illustrating the pressure vessel assembly in FIG. 8 when viewed from the second protector.

FIG. 10 is an enlarged cross-sectional view illustrating a coupling structure between a closed nozzle part and the nozzle part protector in FIG. 8.

### DETAILED DESCRIPTION OF ILLUSTRATIVE EMBODIMENTS

Hereinafter, the disclosed embodiment will be described in detail with reference to the accompanying drawings.

However, the technical spirit of the disclosed embodiment is not limited to some embodiments described herein but may be implemented in various different forms. One or more of the constituent elements in the embodiments may be selectively combined and substituted for use within the scope of the technical spirit of the disclosed embodiment.

In addition, unless otherwise specifically and explicitly defined and stated, the terms (including technical and scientific terms) used in the disclosed embodiment may be construed as the meaning which may be commonly understood by the person with ordinary skill in the art to which the disclosed embodiment pertains. The meanings of the commonly used terms such as the terms defined in dictionaries may be interpreted in consideration of the contextual meanings of the related technology.

In addition, the terms used in the disclosed embodiment are for explaining the embodiments, not for limiting the disclosed embodiment.

In the disclosed embodiment, unless particularly stated otherwise, a singular form may also include a plural form. The expression "at least one (or one or more) of A, B, and C" may include one or more of all combinations that can be made by combining A, B, and C.

In addition, the terms such as first, second, A, B, (a), and (b) may be used to describe constituent elements of the disclosed embodiment.

These terms are used only for the purpose of discriminating one constituent element from another constituent element, and the nature, the sequences, or the orders of the constituent elements are not limited by the terms.

Further, when one constituent element is described as being 'connected,' 'coupled,' or 'attached' to another constituent element, one constituent element may be connected, coupled, or attached directly to another constituent element or connected, coupled, or attached to another constituent element through still another constituent element interposed therebetween.

In addition, the expression "one constituent element is provided or disposed above (on) or below (under) another constituent element" includes not only a case in which the two constituent elements are in direct contact with each other, but also a case in which one or more other constituent elements are provided or disposed between the two constituent elements. The expression "above (on) or below (under)" may mean a downward direction as well as an upward direction based on one constituent element.

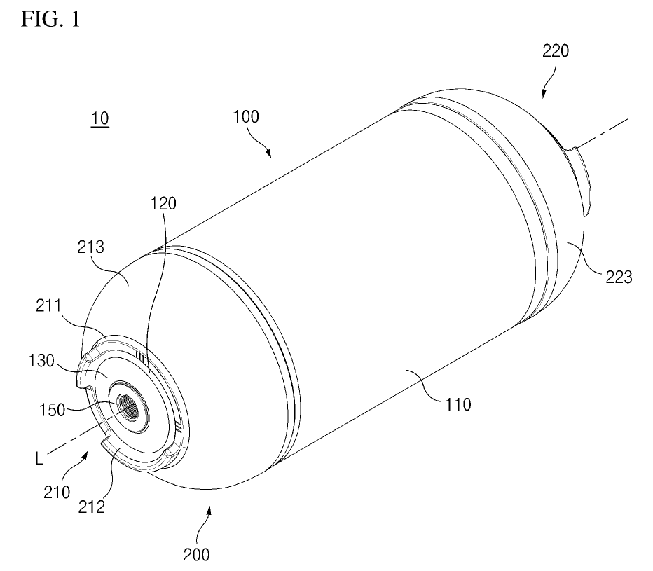

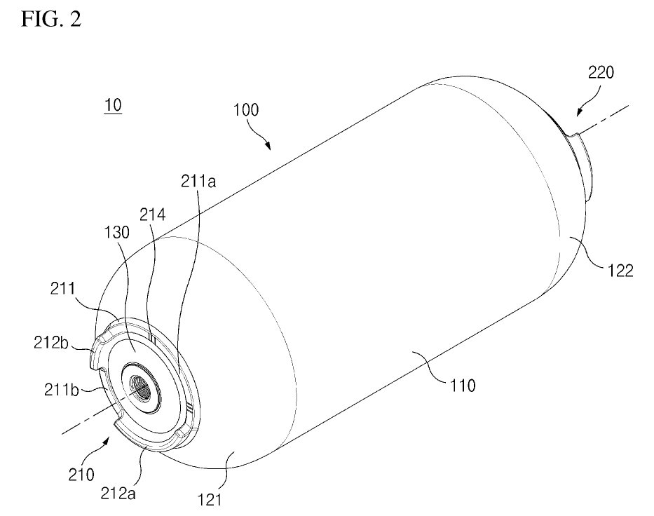

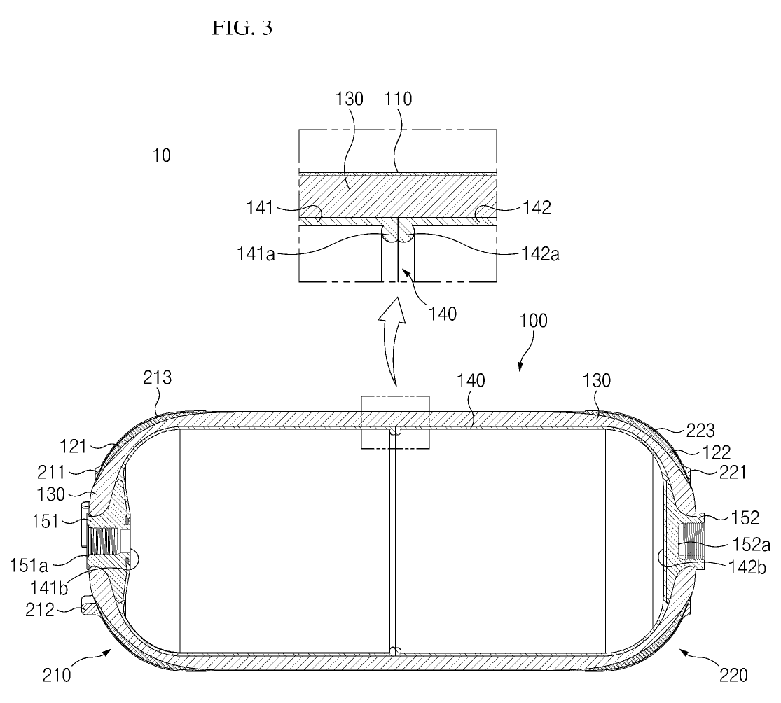

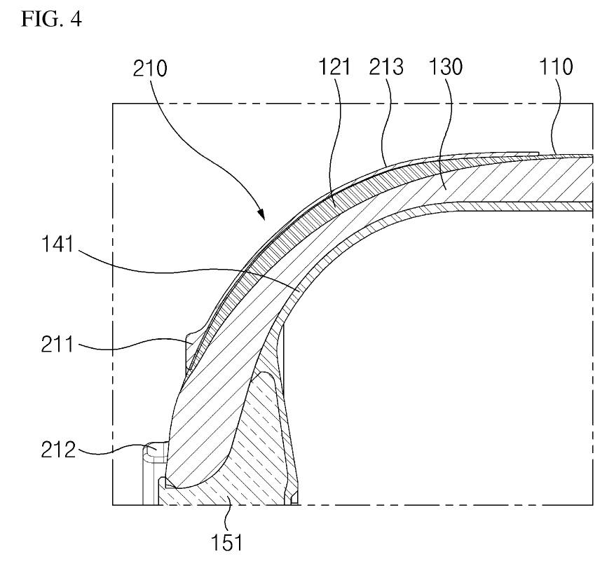

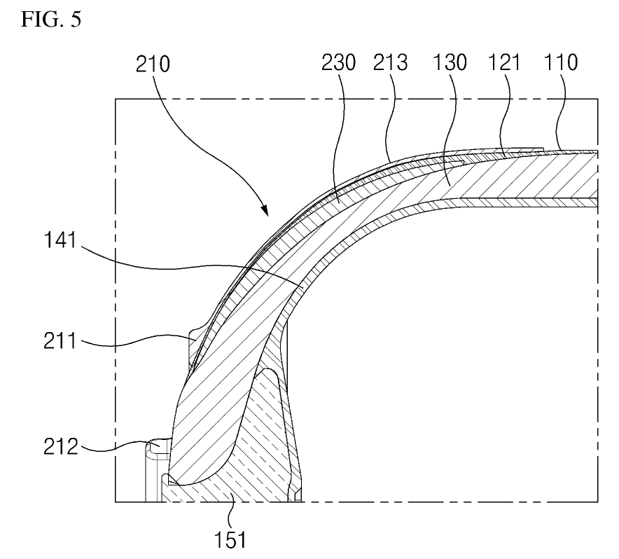

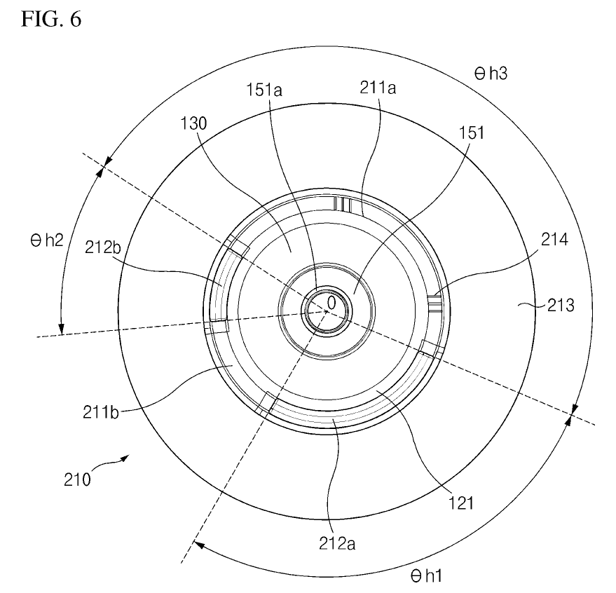

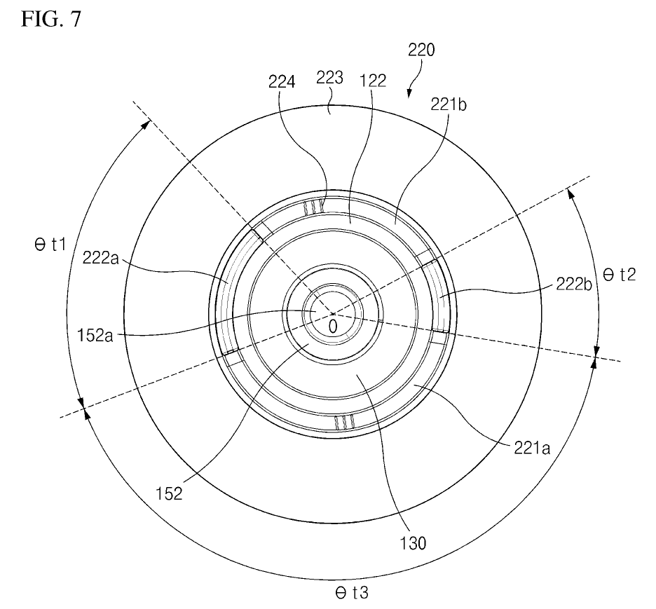

FIG. 1 is a perspective view illustrating a pressure vessel assembly according to an embodiment of the present disclosure. FIG. 2 is a perspective view illustrating the pressure vessel assembly excluding a protector body in the embodiment in FIG. 1. FIG. 3 is a cross-sectional view for explaining an internal configuration of the pressure vessel assembly according to the embodiment of the present disclosure. FIG. 4 is an enlarged cross-sectional view illustrating a coupling structure between a protector and a pressure vessel according to the embodiment of the present disclosure. FIG. 5 is an enlarged cross-sectional view illustrating the pressure vessel assembly including a second reinforcement layer according to another embodiment in FIG. 4. FIG. 6 is a side view illustrating the pressure vessel assembly according to the embodiment of the present disclosure when viewed from a first protector. FIG. 7 is a side view illustrating the pressure vessel assembly according to the embodiment of the present disclosure when viewed from a second protector.

With reference to FIGS. 1-7, a pressure vessel assembly 10 according to the disclosed embodiment may include one or both of a pressure vessel 100 and protectors 200.

For reference, the pressure vessel assembly 10 according to the disclosed embodiment may be used to store a high-pressure fluid (liquid or gaseous fluid). The disclosed embodiment is not restricted or limited by types and properties of fluids to be stored in the pressure vessel 100.

Hereinafter, an example will be described in which the pressure vessel assembly 10 according to the disclosed embodiment is used as a hydrogen tank for a hydrogen storage system applied to mobility vehicles such as various fuel cell vehicles (e.g., a truck), ships, and aircraft to which a fuel cell stack may be applied.

The pressure vessel 100 may include all or some of a cylinder part 110, dome parts 120, and nozzle parts 150.

The cylinder part 110 may be formed to have a substantially hollow cylindrical shape. For example, the cylinder part 110 may be made of a woven fiberglass fabric. For reference, the woven fiberglass fabric may be variously changed in woven shape and structure in accordance with required conditions and design specifications. The disclosed embodiment is not restricted or limited by the woven shape and structure of the woven fiberglass fabric.

The dome parts 120 may have dome shapes formed at two opposite longitudinal ends of the cylinder part 110. An opening portion may be formed at one side of the dome part 120. For example, the dome part 120 may be made of a woven fiberglass fabric.

For reference, the woven fiberglass fabric may be variously changed in woven shape and structure in accordance with required conditions and design specifications. The disclosed embodiment is not restricted or limited by the woven shape and structure of the woven fiberglass fabric.

The dome parts 120 may include one or both of a first dome part 121 and a second dome part 122. The first dome part 121 may have a dome shape formed at one longitudinal end of the cylinder part 110. The second dome part 122 may have a dome shape formed at the other longitudinal end of the cylinder part 110.

More specifically, the pressure vessel 100 may further include one or both of a liner 140 and a first reinforcement layer 130.

The liner 140 may be disposed along the inner surface of the first reinforcement layer 130 and may function as a supporting component of the hollow structure of the pressure vessel as the storage space. High-pressure compressed hydrogen may be stored in the storage space. For example, the liner 140 may be made of a nonmetallic material such as high-density plastic with excellent restoring force and excellent fatigue resistance.

For reference, according to an embodiment different from the disclosed embodiment, the liner 140 may be made of a metallic material (e.g., aluminum). However, the liner 140 may be formed from variously materials in accordance with required conditions and design specifications. The disclosed embodiment is not restricted or limited by the material of the liner 140.

The liner 140 may include one or both of a first liner 141 and a second liner 142. In consideration of manufacturing efficiency and the convenience of assembling, the liner 140 may be divided into the first liner 141 and the second liner 142 instead of being integrated.

The first liner 141 may be formed along an inner peripheral surface of both a first portion of the cylinder part 110 and the first dome part 121, and the second liner 142 may be formed along an inner peripheral surface of both a second portion of the cylinder part 110 and the second dome part 122.

The first liner 141 may include first liner coupling portions 141a. The first liner coupling portions 141a may be formed inward at two opposite ends of the first liner 141.

The second liner 142 may include second liner coupling portions 142a. The second liner coupling portions 142a may be formed inward at two opposite ends of the second liner 142.

The first liner coupling portions 141a and the second liner coupling portions 142a may be joined while being in contact with one another. Examples of the joining methods may include laser welding, thermal bonding, bonding agent application, and the like. However, the disclosed embodiment is not limited thereto. Various joining means may be applied.

The first liner 141 may have a first liner hole 141b formed at one side of the first liner 141 so that the first liner hole 141b fluidly communicates with an inlet/outlet port 151a formed in an open nozzle part 151. The first liner hole 141b may be configured such that the fluid stored in the pressure vessel 100 may be connected to an external device through the inlet/outlet port 151a.

The second liner 142 may include a second liner sealing part 142b formed at one side of the second liner 142 and configured to seal gas.

The first reinforcement layer 130 may be provided to correspond to an inner peripheral surface of the cylinder part 110 and the inner peripheral surfaces of the dome parts 120. For example, the first reinforcement layer 130 may be made of a carbon fiber composite material. The first reinforcement layer 130 may be formed by winding the carbon fiber composite material, which contains epoxy resin or thermosetting resin, around an outer surface of the liner 140.

The structure of the wound carbon fiber composite material and the method of winding the carbon fiber composite material may be variously changed in accordance with required conditions and design specifications. The disclosed embodiment is not limited or restricted by the method of winding the carbon fiber composite material.

The first reinforcement layer 130 may be made by winding multiple layers of the carbon fiber composite material around the outer surface of the liner 140 in various patterns (e.g., clockwise winding, counterclockwise winding, oblique winding, etc.). For example, the carbon fiber composite material may be wound around the outer surface of the liner 140 by a winding jig (not illustrated). The winding angle of the carbon fiber composite material with respect to the liner 140 may be changed by adjusting an angle (posture) at which the winding jig is disposed with respect to the liner 140.

The carbon fiber composite material wound around the outer surface of the liner 140 is cured through a subsequent heat treatment process, thereby forming the first reinforcement layer 130. For example, the carbon fiber composite material wound around the outer surface of the liner 140 may be cured by performing the heat treatment at a temperature of 150°C or higher for a predetermined time.

The nozzle part 150 may be inserted into the opening portion formed at one side of the dome part 120. The nozzle parts 150 may include one or both of the open nozzle part 151 and a closed nozzle part 152.

Specifically, the open nozzle part 151 may be inserted into the opening portion formed at one side of the first dome part 121. The inlet/outlet port 151a having a hole shape may be formed in the open nozzle part 151 and fluidly connected to the external device. Specifically, the inlet/outlet port 151a, through which hydrogen is introduced/discharged, may be formed at one side of an upper end of the open nozzle part 151, and various types of components, such as a valve and a pipe, may be connected to the inlet/outlet port 151a.

For reference, in the disclosed embodiment illustrated and described above, the example has been described in which the inlet/outlet port 151a for introducing and discharging hydrogen is provided in the open nozzle part 151. However, according to an embodiment different from the disclosed embodiment, ports (inlet and outlet ports) for introducing and discharging hydrogen may be respectively provided in the open nozzle part 151 and the closed nozzle part 152, or the inlet/outlet port 151a may be provided in the closed nozzle part 152.

The closed nozzle part 152 may be inserted into the opening portion formed at one side of the second dome part 122. The closed nozzle part 152 may have a sealed shape to prevent a leak of the fluid. A groove portion 152a may be formed at one side of an upper end of the closed nozzle part 152 so that the closed nozzle part 152 is mechanically fastened to a valve or a pipe. The corresponding region may be configured as a sealed structure having no opening portion for fluid connection.

The protector 200 may be provided to surround an outer peripheral surface of the dome part 120. Specifically, the protectors 200 are provided to ensure structural rigidity of the first dome part 121 and the second dome part 122, minimize impact transmitted to the pressure vessel 100 because of external impact such as dropping, and minimize damage to and breakage of the pressure vessel 100.

The protectors 200 may include all or some of guide portions 211 and 221, protruding portions 212 and 222, and protector bodies 213 and 223. The protector 200 may be configured as a first protector 210 or a second protector 220 depending on an installation position.

Specifically, according to the embodiment, the protectors 200, which include only the guide portions 211 and 221 and the protruding portions 212 and 222 without having the protector bodies 213 and 223, may be attached directly to the pressure vessel 100. The protectors 200 configured as described above may have partially degraded impact mitigation performance for inclined dropping (e.g., dropping at 45 degrees) in comparison with the configuration to which the protector bodies 213 and 223 are applied. However, impact mitigation performance for vertical dropping may be substantially maintained, such that the protector body may be selectively applied in accordance with a vulnerability mode based on a dropping direction. Therefore, the structure of the protector 200 may be simplified, thereby improving manufacturing efficiency and spatial utilization.

That is, components of the protectors 200 may vary depending on the desired level of impact mitigation provided by different structural configurations. For example, in one embodiment, the protectors 200 may include all the guide portions 211 and 221, the protruding portions 212 and 222, and the protector bodies 213 and 223. In another embodiment, the protectors 200 may include only the guide portions 211 and 221 and the protruding portions 212 and 222, with the protector bodies 213 and 223 omitted.

Meanwhile, the protector 200 may be made of a polymer material, such as polyurethane, having high elasticity in order to effectively absorb external impact and reduce a load transmitted to the pressure vessel 100. The material may effectively disperse impact based on a high restoring force and flexibility. The material has excellent flame resistance and chemical resistance, thereby ensuring both stability and durability of the protective structure of the pressure vessel 100 that stores the high-pressure fluid. However, the material of the protector 200 is not limited to the above-mentioned example. The material of the protector 200 may be substituted with various polymer materials, composite materials, or other elastic materials depending on the required performance, user environments, design conditions, and the like.

The protector 200 may be fixed to an outer peripheral surface of the pressure vessel 100 by a bonding agent. A bonding agent having excellent flexibility, such as a silicon-based bonding agent, may be used as the bonding agent in order to prevent deformation caused by a difference in thermal contraction or thermal expansion that may occur in low-temperature or high-temperature environments. The above-mentioned configuration may contribute to dispersing a load during impact transmission and reducing damage caused by a difference in stress between materials. However, the bonding agent is not limited thereto. Various types of bonding agents or coupling means may be applied depending on the use environment, material properties, and required performance.

The guide portions 211 and 221 may each extend outward in the longitudinal direction along a periphery of the opening portion formed at one side of the dome part 120. The guide portions 211 and 221 may be divided into regions (hereinafter, referred to as protruding regions 212a, 212b, 222a, and 222b) in which the plurality of protruding portions 212 and 222 are formed, and regions (hereinafter, referred to as non-protruding regions 211a, 211b, 221a, and 221b) other than the regions in which the protruding portions 212 and 222 are provided. For example, at least some of the non-protruding regions 211a, 211b, 221a, and 221b in the guide portions 211 and 221 may be formed such that central angles θh3 and θt3 are each 150 degrees or more on the basis of a longitudinal center axis O of the cylinder part 110 in order to guide an intended tilting direction of the pressure vessel 100. However, the central angles θh3 and θt3 are provided for illustrative purposes only. The non-protruding regions 211a, 211b, 221a, and 221b of the guide portions 211 and 221 may have the central angles θh3 and θt3 of less than 150 degrees depending on design conditions, impact directions, dropping manners, or the like. Therefore, the technical spirit of the disclosed embodiment is not limited to a particular numerical value of the central angle.

The structural characteristics and operational effects of the guide portions 211 and 221 described in the disclosed embodiment may be equally applied to a first guide portion 211 and a second guide portion 221 respectively corresponding to the first protector 210 and the second protector 220.

The protruding portions 212 and 222 may each be formed as one or more protruding portions protruding outward in the longitudinal direction from at least a partial region of each of the guide portions 211 and 221. The protruding portions 212 and 222 may protrude outward in the longitudinal direction beyond an outer end of the nozzle part 150. A shape of each of the protruding portions 212 and 222 may be formed as a partially tapered shape, a curved shape, an inclined surface shape, a stepped shape, an offset shape, a rounded shape, or the like. However, the shapes of the protruding portions 212 and 222 are not limited thereto. The shapes of the protruding portions 212 and 222 may be variously modified depending on the required dropping impact mitigation performance and design conditions.

The structural characteristics and operational effects of the protruding portions 212 and 222 described in the disclosed embodiment may be equally applied to a first protruding portion 212 and a second protruding portion 222 respectively corresponding to the first protector 210 and the second protector 220.

The protector bodies 213 and 223 may be fixed to the outer peripheral surfaces of the dome parts 120. Specifically, the protector bodies 213 and 223 may be provided to surround the outer peripheral surfaces of the dome parts 120. The guide portions 211 and 221 may each extend outward in the longitudinal direction from one side of each of the protector bodies 213 and 223.

The structural characteristics and operational effects of the protector bodies 213 and 223 described in the disclosed embodiment may be equally applied to a first protector body 213 and a second protector body 223 respectively corresponding to the first protector 210 and the second protector 220.

The protectors 200 may include the first protector 210 corresponding to the first dome part 121, and the second protector 220 corresponding to the second dome part 122.

The first protector 210 may be provided to surround an outer peripheral surface of the first dome part 121. The first protector 210 may include all or some of the first guide portion 211, the first protruding portion 212, and the first protector body 213.

The non-protruding regions 211a and 211b of the first guide portion 211 may be asymmetrically disposed on the first protector 210 with respect to the longitudinal center axis O of the cylinder part 110. For example, the non-protruding regions 211a and 211b may be divided into a first-first non-protruding region 211a that is a relatively large region based on a central angle, and a first-second non-protruding region 211b that is a relatively small region. For example, the central angle θh3 of the first-first non-protruding region 211a may be 150 degrees or more, thereby guiding the tilting of the pressure vessel 100 during dropping. However, the central angle θh3 is provided for illustrative purposes only. The non-protruding regions 211a and 211b of the first guide portion 211 may be formed such that the central angle θh3 is less than 150 degrees depending on design conditions, impact directions, dropping manners, or the like. Therefore, the technical spirit of the disclosed embodiment is not limited to a particular numerical value of the central angle.

First identification indicators 214 may be formed at one side of the first guide portion 211 of the first protector 210. Specifically, the first identification indicators 214 may be disposed on the non-protruding regions 211a and 211b of the first guide portion 211 in which the first protruding portion 212 is not formed. Therefore, the first identification indicators 214 may be configured to visually distinguish an installation direction or an assembling position of the pressure vessel 100. For example, the first identification indicator 214 may include an engraving structure formed to be debossed or embossed and configured to enable visual or tactile differentiation.

The first protector 210 may have the plurality of first protruding portions 212. The plurality of first protruding portions 212 may be asymmetrically disposed on the first protector 210 based on the longitudinal center axis O of the cylinder part 110.

The plurality of first protruding portions 212 may each be formed in an arc shape of a fan shape based on the center axis O. Among the plurality of first protruding portions, two or more first protruding portions may be formed to have different central angles. More specifically, at least one of the plurality of first protruding portions 212 may be formed to have a central angle different from that of another first protruding portion among the plurality of first protruding portions 212. For example, a central angle θh1 of a first-first protruding portion 221a, which is at least one of the plurality of first protruding portions 212, may be larger than a central angle θh2 of a first-second protruding portion 221b that is another first protruding portion 212.

The first protector body 213 may be fixed to the outer peripheral surface of the first dome part 121. Specifically, the first protector body 213 may be provided to surround the outer peripheral surface of the first dome part 121.

The second protector 220 may be provided to surround an outer peripheral surface of the second dome part 122. The second protector 220 may include all or some of the second guide portion 221, the second protruding portion 222, and the second protector body 223.

The non-protruding regions 221a and 221b of the second guide portion 221 may be asymmetrically disposed on the second protector 220 with respect to the longitudinal center axis O of the cylinder part 110. For example, the non-protruding regions 221a and 221b may be divided into a second-first non-protruding region 221a that is a relatively large region based on the central angle, and a second-second non-protruding region 221b that is a relatively small region. For example, the central angle θt3 of the second-first non-protruding region 221a may be 150 degrees or more, thereby guiding the tilting of the pressure vessel 100 during dropping. However, the central angle θt3 is provided for illustrative purposes only. The non-protruding regions 221a and 221b of the second guide portion 221 may be formed such that the central angle θt3 is less than 150 degrees depending on design conditions, impact directions, dropping manners, or the like. Therefore, the technical spirit of the disclosed embodiment is not limited to a particular numerical value of the central angle.

Second identification indicators 224 may be formed at one side of the second guide portion 221 of the second protector 220. Specifically, the second identification indicators 224 may be disposed on the non-protruding regions 221a and 221b of the second guide portion 221 in which the second protruding portion 222 is not formed. Therefore, the second identification indicators 224 may be configured to visually distinguish the installation direction or the assembling position of the pressure vessel 100. For example, the second identification indicator 224 may include an engraving structure formed to be debossed or embossed and configured to enable visual or tactile differentiation.

The first identification indicator 214 and the second identification indicator 224 may be formed to be different in arrangement manners or shapes in order to clarify the assembling direction and allow the first and second protectors to be easily distinguished visually.

The second protector 220 may have the plurality of second protruding portions 222. The plurality of second protruding portions 222 may be asymmetrically disposed on the second protector 220 based on the longitudinal center axis O of the cylinder part 110.

The plurality of second protruding portions 222 may each be formed in an arc shape of a fan shape based on the center axis O. Among the plurality of second protruding portions, two or more second protruding portions may be formed to have different central angles. More specifically, at least one of the plurality of second protruding portions 222 may be formed to have a central angle different from that of another second protruding portion among the plurality of second protruding portions 222. For example, a central angle θt1 of a second-first protruding portion 222a, which is at least one of the plurality of second protruding portions 222, may be larger than a central angle θt2 of a second-second protruding portion 222b that is another second protruding portion 222.

The second protector body 223 may be fixed to the outer peripheral surface of the second dome part 122. Specifically, the second protector body 223 may be provided to surround the outer peripheral surface of the second dome part 122.

At least some of the plurality of first protruding portions 212 may be disposed to be spaced apart from at least some of the plurality of second protruding portions 222 when the pressure vessel assembly 10 is viewed from one side based on the longitudinal direction. For example, the first-first protruding portion 221a, which is at least one of the plurality of first protruding portions 212, may be disposed at a position spaced apart from the second-first protruding portion 222a, which is at least one of the plurality of second protruding portions 222, when viewed from one side of the pressure vessel assembly 10 based on the longitudinal direction. This arrangement may prevent the first protruding portion 212 and the second protruding portion 222 from overlapping each other in a radial direction, thereby guiding the tilting direction during impact or dispersing the impact.

Meanwhile, as illustrated in FIG. 5, according to another example of the disclosed embodiment, the protector 200 may further include a second reinforcement layer 230. The second reinforcement layer 230 may be provided to correspond to the inner peripheral surface of each of the protector bodies 213 and 223. The second reinforcement layer 230 is configured to mitigate impact applied directly to the dome part 120 from the outside and complementarily enhance flame resistance, chemical resistance, scratch resistance, impact resistance, and the like of the protector 200.

In addition, the second reinforcement layer 230 may be made of a heat-resistant polymer material, chemical reinforced resin, or a high-elasticity absorbent material (e.g., polyurea, silicon resin, etc.). The second reinforcement layer 230 may be stacked on an inner surface of the protector 200 or interposed between the dome part 120 and the protector 200. The material, arrangement structure, and forming method of the second reinforcement layer 230 are not limited thereto and may be variously modified depending on design objectives and performance requirements.

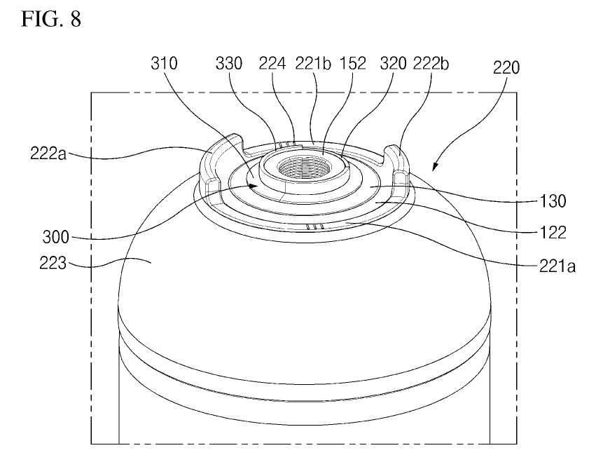

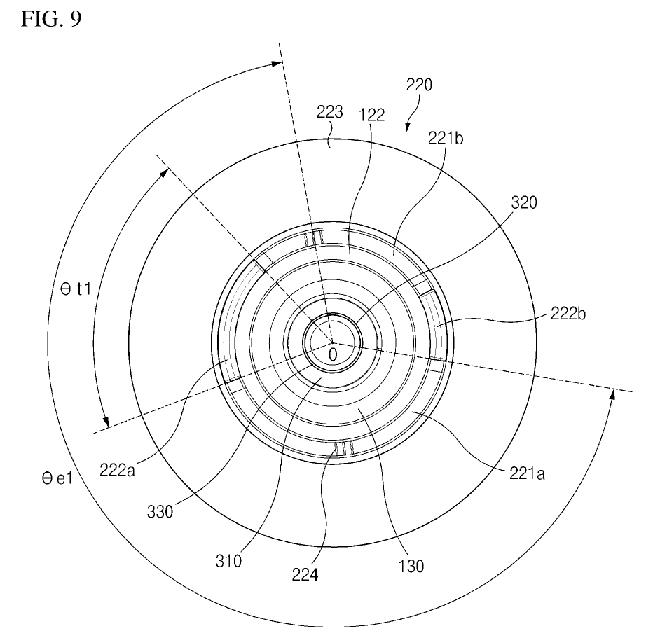

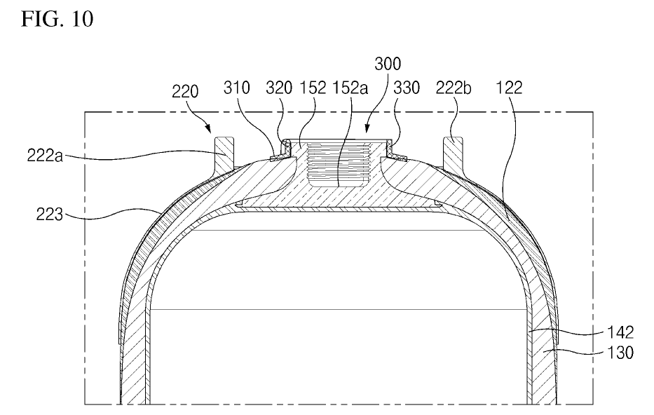

FIG. 8 is a perspective view illustrating the pressure vessel assembly including a nozzle part protector according to another embodiment in FIG. 7. FIG. 9 is a side view illustrating the pressure vessel assembly in FIG. 8 when viewed from the second protector. FIG. 10 is an enlarged cross-sectional view illustrating a coupling structure between the closed nozzle part and the nozzle part protector in FIG. 8.

With reference to FIGS. 8-10, the pressure vessel assembly 10 according to the disclosed embodiment may further include a nozzle part protector 300. The nozzle part protector 300 may be formed to surround an outer peripheral surface of a region protruding outward from the nozzle part 150. For example, the closed nozzle part 152 does not have the inlet/outlet port 151a, and the closed nozzle part 152 is not fluid-connected to the external device. Therefore, the corresponding region is a region that does not interfere with the external device. Therefore, the nozzle part protector 300 may be formed to surround the outer peripheral surface of the region protruding outward from the closed nozzle part 152.

For reference, in the disclosed embodiment illustrated and described above, the example has been described in which the nozzle part protector 300 is formed to surround the outer peripheral surface of the region protruding outward from the closed nozzle part 152. However, according to an embodiment different from the disclosed embodiment, the nozzle part protector 300 may be formed to surround an outer peripheral surface of a region protruding outward from the open nozzle part 151 in case that the inlet/outlet port 151a is formed only in the closed nozzle part 152 without being formed in the open nozzle part 151. In addition, in case that the inlet/outlet ports 151a are provided in both the open nozzle part 151 and the closed nozzle part 152, the nozzle part protector 300 may be excluded or substituted with another shape.

The nozzle part protector 300 may include all or some of a body portion 310, a connection portion 320, and a protrusion portion 330.

The body portion 310 may be provided to surround at least a part of the pressure vessel 100. Specifically, the body portion 310 may be formed to surround at least a part of the first reinforcement layer 130 corresponding to the second dome part 122, and the body portion 310 may be fixed to an outer peripheral surface of the first reinforcement layer 130.

The connection portion 320 may extend outward in the longitudinal direction from the body portion 310. Specifically, the connection portion 320 may be divided into a region (hereinafter, referred to as a protrusion region 330) in which the protrusion portion 330 is formed, and a region (hereinafter, referred to as a non-protrusion region 320a) excluding the region in which the protrusion portion 330 is provided. For example, the non-protrusion region 320a of the connection portion 320 may be formed to have a central angle of 150 degrees or more based on the longitudinal center axis O of the cylinder part 110 in order to guide the intended tilting direction of the pressure vessel 100. However, this is provided for illustrative purposes only, and the disclosed embodiment is not limited to a particular central angle.

The protrusion portion 330 may be formed as one or more protrusion portions protruding outward in the longitudinal direction from one side of the connection portion 320. The protrusion portion 330 may protrude outward in the longitudinal direction beyond an outer end of the nozzle part 150. That is, the protrusion portion 330 may protrude outward in the longitudinal direction beyond an outer end of the closed nozzle part 152.

At least a part of the second protruding portion 222 and at least a part of the protrusion portion 330 may be disposed in different radial directions based on the center axis O of the cylinder part 110. For example, the "radial direction" refers to a direction or position occupied by each of the second protruding portion 222 and the protrusion portion 330 based on an imaginary radius line set to radiate outward from the center axis O of the cylinder part 110. For example, the second protruding portion 222 may be disposed based on a 0-degree direction at a reference point, and the protrusion portion 330 may be disposed in another radial direction (e.g., 90-degree direction) spaced apart from the 0-degree direction. As described above, at least a part of the second protruding portion 222 and at least a part of the protrusion portion 330 may be configured not to be disposed on the same radius line.

While the embodiments have been described above, the embodiments are just illustrative and not intended to limit the disclosed embodiment. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the disclosed embodiment defined by the appended claims.

What is claimed is:

1. A pressure vessel assembly comprising:
a pressure vessel comprising a cylinder part, dome parts having dome shapes formed at two opposite longitudinal ends of the cylinder part, and a nozzle part inserted into an opening portion formed at one side of the dome part; and
protectors provided to surround outer peripheral surfaces of the dome parts;
wherein the dome parts comprise:
a first dome part having a dome shape formed at one longitudinal end of the cylinder part; and
a second dome part having a dome shape formed at the other longitudinal end of the cylinder part; and
wherein each of the protectors comprises:
a guide portion extending outward in the longitudinal direction along a periphery of the opening portion; and
one or more protruding portions protruding outward in the longitudinal direction from at least a partial region of the guide portion.

2. The pressure vessel assembly of claim 1, wherein the protruding portions extend outward in the longitudinal direction beyond an outer end of the nozzle part.

3. The pressure vessel assembly of claim 1, wherein at least a partial region of a region of the guide portion, which excludes a region in which the protruding portion is provided, has a central angle of 150 degrees or more based on a longitudinal center axis of the cylinder part.

4. The pressure vessel assembly of claim 1, wherein the protectors further comprise:
a first protector surrounds an outer peripheral surface of the first dome part; and
a second protector surrounds an outer peripheral surface of the second dome part, and
wherein the protruding portions comprise:
a plurality of first protruding portions asymmetrically disposed on the first protector with respect to a longitudinal center axis of the cylinder part; and
a plurality of second protruding portions asymmetrically disposed on the second protector with respect to the longitudinal center axis.

5. The pressure vessel assembly of claim 4, wherein each of the first protruding portions has a fan-shape that extends along an arc segment centered on a central axis, and wherein two or more first protruding portions, among the plurality of first protruding portions, are formed to have different central angles.

6. The pressure vessel assembly of claim 4, wherein at least some of the plurality of first protruding portions are spaced apart from at least some of the plurality of second protruding portions when the pressure vessel assembly is viewed from one side based on the longitudinal direction.

7. The pressure vessel assembly of claim 1, wherein both the cylinder part and the dome part comprise a woven fiberglass fabric.

8. The pressure vessel assembly of claim 1, wherein the pressure vessel further comprises:
a first reinforcement layer disposed along inner peripheral surfaces of the cylinder part and the dome part; and
a liner disposed along an inner peripheral surface of the first reinforcement layer and configured to define a storage space within the pressure vessel.

9. The pressure vessel assembly of claim 8, wherein the first reinforcement layer comprises a carbon fiber composite material, and the liner comprises a plastic material.

10. The pressure vessel assembly of claim 1, wherein each protector further comprises:
a protector body fixed to the outer peripheral surface of the dome part; and
a second reinforcement layer disposed along an inner peripheral surface of the protector body.

11. The pressure vessel assembly of claim 4, further comprising a nozzle part protector surrounding an outer peripheral surface of a region protruding outward from the nozzle part.

12. The pressure vessel assembly of claim 11, wherein the nozzle part protector comprises:
a body portion surrounding at least a portion of the pressure vessel;
a connection portion extending outward in the longitudinal direction from the body portion; and
one or more protrusion portions protruding outward in the longitudinal direction from one side of the connection portion.

13. The pressure vessel assembly of claim 12, wherein the protrusion portion protrudes outward in the longitudinal direction beyond an outer end of the nozzle part.

14. The pressure vessel assembly of claim 12, wherein at least a portion of the second protruding portion and at least a portion of the protrusion portion are positioned in different radial directions relative to a center axis of the cylinder part.

15. The pressure vessel assembly of claim 4, wherein the nozzle part further comprises:
an open nozzle part having a hole configured to fluidly connect the open nozzle part to an external device; and
a closed nozzle part having a sealed shape configured to prevent leakage.

16. The pressure vessel assembly of claim 4, wherein:
a first identification indicator is formed on one side of the guide portion of the first protector;
a second identification indicator is formed on one side of the guide portion of the second protector; and
the first and the second identification indicators differ in arrangement or shape.

17. A pressure vessel assembly comprising:
a pressure vessel comprising a cylinder part, a first dome part having a dome shape formed at one longitudinal end of the cylinder part, a second dome part having a dome shape formed at the other longitudinal end of the cylinder part, and a nozzle part inserted into an opening portion formed in one of the dome parts;
a first protector surrounding an outer peripheral surface of the first dome part and comprising a first guide portion extending outward in a longitudinal direction along a periphery of the opening portion and a plurality of first protruding portions protruding outward in the longitudinal direction from the first guide portion; and
a second protector surrounding an outer peripheral surface of the second dome part and comprising a second guide portion extending outward in the longitudinal direction along a periphery of the opening portion and a plurality of second protruding portions protruding outward in the longitudinal direction from the second guide portion;
wherein the plurality of first protruding portions are asymmetrically disposed on the first protector with respect to a longitudinal center axis of the cylinder part, and the plurality of second protruding portions are asymmetrically disposed on the second protector with respect to the longitudinal center axis; and
wherein at least some of the plurality of first protruding portions are spaced apart from at least some of the plurality of second protruding portions when the pressure vessel assembly is viewed from one side in the longitudinal direction.

18. The pressure vessel assembly of claim 17, wherein:
each of the plurality of first protruding portions has a fan shape extending along an arc segment centered on the longitudinal center axis;
two or more first protruding portions among the plurality of first protruding portions have different central angles; and
each of the plurality of second protruding portions has a fan shape extending along an arc segment centered on the longitudinal center axis, with two or more second protruding portions among the plurality of second protruding portions having different central angles.

19. A pressure vessel assembly comprising:
a pressure vessel comprising a cylinder part, dome parts having dome shapes formed at two opposite longitudinal ends of the cylinder part, and a nozzle part inserted into an opening portion formed at one side of a dome part; and
protectors surrounding outer peripheral surfaces of the dome parts, each protector comprising a guide portion extending outward in a longitudinal direction along a periphery of the opening portion and one or more protruding portions protruding outward in the longitudinal direction from the guide portion;
wherein the guide portion includes protruding regions where the protruding portions are formed and non-protruding regions where no protruding portions are provided;
wherein at least a partial region of the non-protruding regions has a central angle of 150 degrees or more based on a longitudinal center axis of the cylinder part; and
wherein the protruding portions extend outward in the longitudinal direction beyond an outer end of the nozzle part.

20. The pressure vessel assembly of claim 19, wherein:
the protectors comprise a first protector surrounding the outer peripheral surface of a first dome part and a second protector surrounding the outer peripheral surface of a second dome part;
a first identification indicator is formed on the non-protruding regions of the first protector and a second identification indicator is formed on the non-protruding regions of the second protector; and
the first identification indicator and the second identification indicator differ in arrangement or shape to visually distinguish installation direction of the pressure vessel assembly.
